(19) United States
(12) Patent Application Publication
(10) Pub. No.: US 2026/0209431 A1
(43) Pub. Date: Jul. 23, 2026

(54) COATING COMPOSITIONS WITH CATALYTIC SYSTEM

(71) Applicant: PPG Industries Ohio, Inc., Cleveland, OH (US)

(72) Inventors: Adam B. Powell, Wexford, PA (US); Hilary Ann Kerchner, Gibsonia, PA (US)

(73) Assignee: PPG Industries Ohio, Inc., Cleveland, OH (US)

(21) Appl. No.: 19/141,157

(22) PCT Filed: Dec. 21, 2023
(86) PCT No.: PCT/US2023/085291

§ 371 Date: Jun. 19, 2025

Related U.S. Application Data
(60) Provisional application No. 63/476,550, filed on Dec. 21, 2022.

(51) Int. Cl. C08G 63/85; B33Y 40/20; B65D 65/42; C08G 18/22; C09D 167/02; C09D 175/08

(52) U.S. Cl. CPC C08G 63/85; B65D 65/42; C08G 18/222; C08G 18/227; C09D 167/02; C09D 175/08; B33Y 40/20

(57) ABSTRACT

Coating compositions comprising a film-forming polymer formed a reaction mixture comprising a catalytic system are disclosed. The catalytic system comprises a first catalyst, comprising titanium, zirconium, or combinations thereof, and a second catalyst comprising bismuth, aluminum, zirconium, or combinations thereof, wherein the metal in the first catalyst is different from the metal in the second catalyst. A method for coating at least a portion of a substrate with said coating compositions is also disclosed. Furthermore, articles coated, at least in part, with said coating compositions are disclosed.

### FIELD

The present disclosure is directed to a coating composition comprising a film-forming polymer formed a reaction mixture comprising a catalyst system comprising a first catalyst comprising titanium or zirconium, or combinations thereof; and a second catalyst comprising bismuth, aluminum, zirconium, or combinations thereof; wherein the metal in the first catalyst is different from the metal in the second catalyst, to a method for coating a substrate comprising applying, to at least a portion of the substrate, said coating composition, and to a substrate coated at least in part with said coating composition.

### BACKGROUND OF THE DISCLOSURE

Coating compositions comprising film-forming polymers formed from reactions comprising catalysts have been widely used in the coatings industry, such as in the packaging industry, coil coatings, and certain industrial and automotive coatings. Catalysts can speed up a reaction, leading to shorter manufacturing times, but often contain materials that are potentially toxic, such as tin. Novel catalysts or catalytic systems to manufacture film-forming polymers and coating compositions are desired, particularly those that reduce or eliminate the use of potentially toxic materials.

### SUMMARY OF THE DISCLOSURE

The present disclosure is directed to a coating composition comprising a film-forming polymer formed a reaction mixture comprising a catalytic system comprising a first catalyst comprising titanium or zirconium, or combinations thereof; and a second catalyst comprising bismuth, aluminum, zirconium, or combinations thereof; wherein the metal in the first catalyst is different from the metal in the second catalyst. The present disclosure is further directed to a method for coating a substrate comprising applying, to at least a portion of the substrate, the coating composition. A substrate coated at least in part with the coating composition is also within the present scope.

### BRIEF DESCRIPTION OF THE FIGURE

FIG. 1 is a graph illustrating the acid value (AV) versus reaction time wherein the AV is used to monitor the reaction progression.

### DETAILED DESCRIPTION OF THE DISCLOSURE

For purposes of the following detailed description, it is to be understood that the disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 4 to 5, etc.). For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “a”, “an”, “the”, “at least one” and “one or more” are used interchangeably. Thus, for example, a coating composition that comprises “a” film-forming polymer, “a” catalyst, or “a” first and second catalyst may be interpreted to mean “one or more” of these items.

Also, as used herein, the term “film forming polymer” is used interchangeably with “polymer” or “resin”, and refers to one or more polymers, such as homopolymers and/or copolymers, as well as prepolymers and/or oligomers, that are capable of forming a film upon reaction with a curing agent or crosslinker, or by drying or self-crosslinking.

As used herein, the term “catalyst” refers to a substance that enables a chemical reaction, such as production of a polymer, to proceed at a faster rate or under different conditions, such as at a lower temperature. Also, as used herein, the term “catalytic system” refers to a combination of two or more different catalysts.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure. As used herein “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described.

In addition, as used herein, the use of “or” means “and/or” unless specifically stated otherwise, even though “and/or” may be explicitly used in certain instances.

As used herein, a “coating composition” refers to a composition, e.g., a solution, a mixture, a powder, or a dispersion, that, in an at least partially dried or cured state, is capable of producing a film layer, or the like, on at least a portion of a substrate surface.

As used herein, the term “crosslinker” or “curing agent” refers to a molecule capable of forming a covalent linkage between polymers or between two different regions of the same polymer.

As used herein, “colorant” refers to any substance that imparts color and/or other opacity and/or other visual effect to the composition.

As used herein, “ambient conditions” generally refer to temperature and humidity conditions or temperature and humidity conditions that are typically found in the area in which a composition is being applied to a substrate, e.g., at 10° C. to 40° C. and 5% to 80% relative humidity, while thermal conditions are temperatures that are above ambient temperature. As used herein, “room temperature” generally refers to ambient temperatures, such as 10° C. to 40° C. As used herein, “substrate” may mean a bare substrate as well as substrate that is previously treated or coated with one or more layers, such as a pretreatment, a primer, and/or a basecoat.

As used herein, unless indicated otherwise, the term “substantially free” means that a particular material is not purposefully added to a mixture or composition, respectively, and is only present as an impurity in a trace amount of 5 ppm or less based on a total weight of the mixture or composition, respectively. As used herein, unless indicated otherwise, the term “essentially free” means that a particular material is only present in an amount of 1 ppm or less based on a total weight of the mixture or composition, respectively. As used herein, unless indicated otherwise, the term “completely free” means that a mixture or composition, respectively, does not comprise a particular material, i.e., the mixture or composition comprises 1 ppb or less of such material based on a total weight of the mixture or composition, or that such material is below the detection limit of common analytical techniques.

The present disclosure is directed to a coating composition, comprising a film-forming polymer formed a reaction mixture comprising a catalyst, wherein the catalyst comprises a catalytic system.

The film-forming polymer may comprise any polymer capable of forming a film, either alone (such as self-crosslinking) or upon reaction with a crosslinker. Useful film-forming polymers include polyesters, such as a polyester with hydroxyl functional groups and/or carboxyl functional groups, and/or polyurethanes, such as a polyurethane with hydroxyl functional groups and/or isocyanate functional groups, as well as acrylic polymers and epoxy resins. The polyester may be prepared by any suitable means known to those in the art, such as by condensation.

The polyester may be prepared from polyacids, or esters or anhydrides thereof, and polyols. Polyols are those molecules having two or more hydroxyl groups within each molecule. Non-limiting examples of polyols include propylene glycol, neopentyl glycol, butylene glycol, hexylene glycol, octylene glycol, 1,6-hexanediol, 1,8-octanediol, 1,9-nonanediol, 1,10-decanediol, 1,12-dodecanediol, 1,2-cyclohexanediol, 1,3-cyclohexanediol, 1,4-cyclohexanediol, 2-methyl-1,3-propanediol, dimethylol propionic acid, trimethylolpropane, pentaerythritol, 4,4′-(propane-2,2-diyl)diphenol, and caprolactone diol.

Polyacids are those molecules having two or more acid groups, such as carboxylic acid groups, within each molecule. Non-limiting examples of polyacids include terephthalic acid, isophthalic acid, adipic acid, succinic acid, azelaic acid, sebacic acid, maleic acid, fumaric acid, cyclohexane dicarboxylic acids, and anhydrides thereof, such as phthalic anhydride, terephthalic anhydride, and terephthalic anhydride.

The polyester may comprise a reaction product of a polyacid, or an ester or anhydride thereof, and a polyol, and/or the polyester may comprise hydroxyl functional groups, and/or carboxyl functional groups.

The polyurethane may be prepared by any suitable means known to those skilled in the art, such as by alcoholysis.

The polyurethane may be prepared from reaction materials such as polyisocyanates and polyols.

Polyisocyanates are those molecules having two or more isocyanate groups within each molecule. Non-limiting examples of polyisocyanates include 1,2,4-benzene triisocyanate, polymethylene polyphenyl isocyanate, 4,4′-diphenylmethane diisocyanate, 1,3-phenylene diisocyanate, 1,4-phenylene diisocyanate, toluene diisocyanate, 1,4-tetramethylene diisocyanate, 1,6-hexamethylene diisocyanate, m-tetramethylxylene diisocyanate, 1,4-cyclohexyl diisocyanate, isophorone diisocyanate, alpha, alpha-xylylene diisocyanate and 4,4-methylene-bis(cyclohexyl isocyanate).

Non-limiting examples of polyols are those having two or more hydroxyl groups within each molecule, such as those described above.

The polyurethane may comprise a reaction product of a polyol, and a polyisocyanate, and/or the polyurethane comprises hydroxyl functional groups.

It will be appreciated by those skilled in the art that the polymer may be processed using additional components, such as amine or epoxy, to impart other functional groups and/or desirable performance properties to the cured coating composition. Examples include, but are not limited to, polyesters prepared with adducts of ethylene oxide with N,N′-diphenylhexane-1,6-diamine, or dicyclopentadiene, or polyisocyanates prepared with substituted organic group-containing polyisocyanates wherein the substituents include nitro, chloro, alkoxy and other groups that are not reactive with hydroxyl groups or active hydrogens and provided the substituents are not positioned to render the isocyanate group unreactive.

Organic solvents may optionally be used in the preparation of the polymer, such as n-butyl alcohol, 2-(2-butoxyethoxy) ethanol, 2-butoxy ethanol, propylene glycol monomethyl ether, propylene glycol monomethyl ether acetate, N-methyl-2-pyrrolidone, methyl ethyl ketone, aromatic solvents such as light aromatic solvent such Aromatic 100 from ExxonMobil, or combinations thereof.

In some cases, the polymer may be dispersed in an aqueous medium, such as by at least partially neutralizing the carboxyl functional polymer with an amine, such as, but not limited to, ammonia, monoethanolamine, diethanol amine or dimethylethanol amine, or by use of surfactants, or by other methods known to those skilled in the art.

As stated above, the catalyst comprises a catalytic system. The catalytic system comprises a first catalyst comprising titanium, zirconium, or combinations thereof; and a second catalyst comprising bismuth, aluminum, zirconium, or combinations thereof, wherein the metal in the first catalyst is different from the metal in the second catalyst.

The first catalyst may comprise titanium, such as Ti(OR¹)₄, wherein R¹ is an alkyl or aryl, such as wherein R¹ is a C3-C20 alkyl, such as wherein R¹ is n-butyl, such as tetra n-butyl titanate (TBT), tetraisopropyl titanate, or titanium (IV) phenoxide, or zirconium, such as Zr(OC(O)R²)₃, wherein R² is an alkyl or aryl, such as zirconium isopropoxide, zirconium butoxide, zirconium octoate, zirconium napthenate, or combinations of any of these. Titanium (IV) butoxide and similar terms may be used interchangeably with tetra n-butyl titanate (TBT).

As stated above, the second catalyst may comprise bismuth, such as Bi(OC(O)R₃)₃, wherein R³ is an alkyl or aryl, wherein R³ is a C5-C20 alkyl, such as wherein R³ is neodecyl, such as bismuth neodecanoate, bismuth octoate, bismuth napthenate, or bismuth carboxylate mixture, or the second catalyst comprises aluminum, such as Al(OC(O)R⁴)₃, wherein R⁴ is an alkyl or aryl, such as aluminum oleate, aluminum octoate, or the second catalyst comprises zirconium, such as any of the aforementioned zirconium compounds, such as Zr(OC(O)R⁵) 3, wherein R⁵ is an alky or aryl or combinations of any of these.

For example, the coating composition may comprise a catalyst system wherein the first catalyst comprises titanium, such as Ti(OR¹)₄, wherein R¹ is an alkyl or aryl, such as wherein R¹ is a C3-C20 alkyl, such as wherein R¹ is n-butyl, such as tetrabutyl titanate, or the first catalyst comprises zirconium, such as Zr(OC(O)R³) 3, wherein R² is an alkyl or aryl, and the second catalyst comprises bismuth, such as Bi(OC(O)R³) 3, wherein R³ is an alkyl or aryl, such as a C5-C20 alkyl, such as wherein R³ is neodecyl, such as bismuth neodecanoate, or the second catalyst comprises aluminum, such as Al(OC(O)R⁴) 3, wherein R⁴ is an alkyl or aryl, or the second catalyst comprises zirconium, such as Zr(OC(O)R⁵) 3, wherein R⁵ is an alky or aryl.

The metal in the first catalyst is different from the metal in the second catalyst of the catalytic system. The catalytic system may comprise, for example, titanium and bismuth, titanium and aluminum, titanium and zirconium, zirconium and bismuth, or zirconium and aluminum. For example, the first catalyst may comprise titanium, such as tetrabutyl titanate, and the second catalyst may comprise bismuth, such as bismuth neodecanoate.

The catalytic system may comprise from 3 to 96 parts by weight of the first catalyst and from 4 to 97 parts by weight of the second catalyst, such as from 7 to 43 parts of the first catalyst and from 9 to 42 parts of the second catalyst, such as 33 parts of the first catalyst and 67 parts of the second catalyst and/or the catalytic system may comprise molar equivalent ratios of from 9:1 to 1:9, such as 4:1 to 1:4, such as 1:1, based on the number of equivalent moles of the first catalyst to the number of equivalent moles of the second catalyst.

The catalyst system may be present in the film-forming polymer comprising the coating composition in any amount no more than 2 percent based on weight percent on resin solids, such as 2 or less, and 1 or less, such as 0.05 or more, and 0.3 or more, such as 0.05 to 2, such as 0.42. As used herein, resin solids refer to the weight percent of a resin remaining after incubation, such as in an oven, at 110° C., for 1 hour.

The first catalyst and the second catalyst comprising the catalytic system may be added individually to produce the film-forming polymer used in the coating composition. Optionally, the first catalyst and the second catalyst may be premixed to make a premix catalytic system, sometimes referred to herein as “premix” and like terms. Premixing refers to blending the components together to homogenize or make a uniform blend of the first catalyst and the second catalyst, or catalytic system. Premixing or blending may be performed using any process, such as, but not limited to, manually stirring with a wooden or metal spatula for several minutes, such as 5-10 minutes, or using a motorized agitator or homogenizer. The first catalyst and second catalyst may be premixed prior to addition to the reaction to form the film-forming polymer.

The first catalyst and second catalyst may be observed to exotherm, or increase in temperature, during the mixing or blending process to manufacture the premix catalytic system.

The premix catalytic system may be used as soon as practically possible, or stored under ambient conditions, optionally under a nitrogen blanket using a process known to those skilled in the art, prior to use in producing the film-forming polymer in the coating composition. The premix may be stored for some length of time, such as from 5 minutes to 2 months, prior to use in producing the film-forming polymer in the coating system.

The catalytic system may be added at any one or more appropriate times during the production of the film-forming polymer. For example, the first catalyst and second catalyst comprising the catalytic system may be added at the same time, or at separate times, once, or at multiple times, to the reaction materials during the production of the film-forming polymer. In other examples, the catalyst system may be premixed and added as a premix, at any one or more stages during the production of the film-forming polymer. As a non-limiting example, the premix catalyst system may be added at the beginning of the reaction to form the film-forming polyurethane polymer.

In some cases, the catalyst system of the present disclosure may be used to produce film-forming polymers, such as polyesters or polyurethanes with a reduced production time as compared with polymers produced with comparable molar equivalents of a single catalysts such as tin, or titanium.

As disclosed herein, the film-forming polymer and/or the coating system may be substantially free, may be essentially free, and/or may be completely free of catalytic tin. Examples of tin catalysts (that is, catalysts containing “catalytic tin”) include but are not limited to dibutyltin dilaurate, dioctyltin dilaurate; dimethyltin oxide; diethyltin oxide; dipropyltin oxide; dibutyltin oxide, dioctyltin oxide, or combinations thereof.

The coating composition may be thermoplastic. As used herein, “thermoplastic” means that the coating composition may dry to form a film upon evaporation of water and/or solvents at ambient temperatures or with exposure to heat or other energy source.

The coating composition may include a crosslinker. The crosslinker may comprise, for example, a melamine-formaldehyde, isocyanate, or blocked isocyanate that is reactive with hydroxyl functional groups, or an epoxy that is reactive with carboxyl functional groups. It will be appreciated that the coating compositions of the disclosure can cure through the reaction between the functional groups of the film-forming polymer, such as a polyester or polyurethane, and the functional groups of the crosslinkers. Curing refers to bond formation between the polymer and crosslinker resulting in the formation of a crosslinked coating film. As described herein, coating compositions that cure or crosslink may be referred to as thermoset whether the curing proceeds under ambient conditions or with exposure to heat or other energy sources.

Non-limiting examples of crosslinkers include phenolic resins, amino resins, epoxy resins, beta-hydroxy (alkyl) amide resins, alkylated carbamate resins, isocyanates such as EHW8224 commercially available from PPG, blocked isocyanates, polyacids, anhydrides, organometallic acid-functional materials, polyamines, polyamides, aminoplasts, such as CYMEL303, CYMEL 322, CYMEL 327, CYMEL 380, and CYMEL1130 (available from ALLNEX), and mixtures thereof.

For example, the coating compositions may further comprise a crosslinker, such as an aminoplast or isocyanate.

The crosslinker may be used in any weight percent of the coating composition dependent on end use or application as known to those skilled in the art.

The coating composition may comprise any coating composition, such as a liquid coating composition, such as a liquid coating composition at room temperature, such as a solvent-based coating composition or a water-based coating composition, and/or the coating composition may be a one component coating composition, and/or the coating composition may be a multi-component coating composition wherein a resin is in one component and a crosslinker therefore is in another component, or the coating composition may be a powder coating composition.

As used herein, “solvent-based” coating compositions refer to coating compositions that are dispersed or diluted in organic medium, such as but not limited to alcohols, acetates, ketones, glycol ethers, and/or hydrocarbon solvents. As used herein, “water-based” coating compositions refer to coating compositions that are dispersed or diluted in aqueous medium.

As used herein, the term “organic medium” refers to a liquid medium comprising less than 50% by weight water, based on the total weight of the organic medium. Such organic mediums may comprise less than 40% by weight water, or less than 30% by weight water, or less than 20% by weight water, or less than 10% by weight water, or less than 5% by weight water, or less than 1% by weight water, or less than 0.1% by weight water, based on the total weight of the organic medium, or may be free of water. Organic solvent(s) comprise more than 50% by weight of the organic medium, such as at least 70% by weight, such as at least 80% by weight, such as at least 90% by weight, such as at least 95% by weight, such as at least 99% by weight, such as at least 99.9% by weight, such as 100% by weight, based on the total weight of the organic medium. The organic solvent(s) may comprise 50.1% to 100% by weight, such as 70% to 100% by weight, such as 80% to 100% by weight, such as 90% to 100% by weight, such as 95% to 100% by weight, such as 99% to 100% by weight, such as 99.9% to 100% by weight, based on the total weight of the organic medium.

As used herein, the term “aqueous medium” refers to a liquid medium comprising at least 50% by weight water, based on the total weight of the organic medium. Such aqueous mediums may comprise less than 40% by weight organic solvent, or less than 30% by weight organic solvent, or less than 20% by weight organic solvent, or less than 10% by weight organic solvent, or less than 5% by weight organic solvent, or less than 1% by weight organic solvent, or less than 0.1% by weight organic solvent, based on the total weight of the aqueous medium. Water may comprise more than 50% by weight of the aqueous medium, such as at least 60% by weight, such as at least 70% by weight, such as at least 80% by weight, such as at least 90% by weight, such as at least 95% by weight, such as at least 99% by weight, such as at least 99.9% by weight, such as 100% by weight, based on the total weight of the aqueous medium. Water may comprise 50.1% to 100% by weight, such as 70% to 100% by weight, such as 80% to 100% by weight, such as 90% to 100% by weight, such as 70% to 100% by weight, such as 80% to 100% by weight, such as 90% to 100% by weight, such as 95% to 100% by weight, such as 99% to 100z % by weight, such as 99.9% to 100%, by weight, based on the total weight of the aqueous medium.

The coating composition may include additional polymers, such as acrylics, polyesters, or polyurethanes, and various additives. Non-limiting examples of additives that may be used with the coating composition of the present disclosure include: colorants, such as pigments or dyes that impart color to a cured film, fillers including, but not limited to, clays, inorganic minerals, abrasion resistant particles, corrosion inhibitors, anti-oxidants, hindered amine light stabilizers, UV light absorbers and stabilizers, surfactants, flow and surface control agents, thixotropic agents, organic solvents, water, reactive diluents, driers, catalysts, reaction inhibitors, adhesion promoters, and other customary additives.

The coating composition of the present disclosure may be a liquid coating composition, such as a solvent-based coating composition or water-based coating composition, or the coating composition may be a powder coating composition.

The coating compositions of the present disclosure may be one-package compositions, or multipackage compositions, such as two-package composition. A one-package composition will be understood as referring to a composition wherein all the coating components are maintained in the same container after manufacture, during storage, etc. For some coatings, such as thermoset coatings that cure at ambient conditions, various components are maintained separately until just prior to application to prevent the components from curing prematurely. For example, the film-forming polymer, such as the polyester, and/or polyurethane or combinations thereof, may be in one package and the crosslinker, such as an aminoplast or isocyanate, may be in another.

The coating composition coating composition may be a liquid coating composition, such as a solvent-based coating composition or a water-based coating composition, or a powder coating composition, and/or the coating composition may be a one component coating composition, and/or the coating composition may be a multi-component coating composition wherein a film-forming polymer is in one component and a crosslinker therefore is in another component.

Coating compositions prepared in accordance with the present disclosure may be applied to substrates by any suitable means known to those skilled in the art. Examples of such suitable application means include, without limitation: coil coating, spraying, flow coating, spin coating, curtain coating and dip coating. Notwithstanding the above, the coating compositions of the present disclosure are suitable for application onto substrates by coil coating techniques, such as in sheets or in a continuous process.

Examples of suitable substrates onto which the present coating compositions may be applied include, without limitation: metal, plastic, wood, glass, and the like. With regard to metal substrates, the present coating compositions are particularly suitable for application onto electrogalvanized steels, hot-dipped galvanized steels, zinc-iron alloy steels, zinc-aluminum cladded steels, zinc-nickel cladded steels, cold-rolled steels, and aluminum.

The coating composition of the present invention may be applied to the substrate, or a portion thereof, as a single layer or as part of a multi layer system. The coating composition may be applied as a single layer. The coating composition may be applied to an uncoated substrate. For the avoidance of doubt, an uncoated substrate extends to a surface that is cleaned prior to application. The coating composition may be applied on top of another paint layer as part of a multi layer system. For example, the coating composition may be applied on top of a primer. The coating may form an undercoat layer or an overcoat layer. The coating composition may form an intermediate layer or a top coat layer. The coating composition may be applied as the first coat of a multi coat system. The second, third, fourth etc. coats may comprise any suitable paint such as those containing, for example, epoxy resins; polyester resins; polyurethane resins; polysiloxane resins; hydrocarbon resins or combinations thereof. The second, third, fourth etc. coats may be a liquid coating or a powder coating. The coating composition may be applied to the substrate once or multiple times.

The coating composition may be applied to a package.

The package may be a metal package. Examples of metal packages include, but are not limited to, food and/or beverage packaging, components used to fabricate such packaging or monobloc aerosol cans and/or tubes. The food and/or beverage packaging may be a can. Examples of suitable cans include, but are not limited to, two-piece cans, three-piece cans, and the like. Suitable examples of monobloc aerosol cans and/or tubes include, but are not limited to, deodorant and hair spray containers. Monobloc aerosol cans and/or tubes may be aluminum monobloc aerosol cans and/or tubes.

The coating composition may be applied to food and/or beverage packaging and/or monobloc aerosol cans and/or tubes or components used to fabricate such packaging.

The application of various pre-treatments and coatings to packaging is well established. Such treatments and/or coatings, for example, can be used in the case of metal cans, wherein the treatment and/or coating is used to retard or inhibit corrosion, provide a decorative coating, provide ease of handling during the manufacturing process, and the like. Coatings can be applied to the interior of such cans to prevent the contents from contacting the metal of the container. Contact between the metal and a food or beverage, for example, can lead to corrosion of a metal container, which can then contaminate the food or beverage. This can be true when the contents of the can are acidic in nature. The coatings applied to the interior of metal cans also help prevent corrosion in the headspace of the cans, which is the area between the fill line of the product and the can lid; corrosion in the headspace can be problematic with food products having a high salt content. Coatings can also be applied to the exterior of metal cans. Certain coating compositions of the present invention may be applicable for use with coiled metal stock, such as the coiled metal stock from which the ends of cans are made (“can end stock”), and end caps and closures are made (“cap/closure stock”). Since coatings designed for use on can end stock and cap/closure stock may be applied prior to the piece being cut and stamped out of the coiled metal stock, they may be flexible and extensible. For example, such stock may be coated on both sides. Thereafter, the coated metal stock is punched. For can ends, the metal is then scored for the “pop-top” opening and the pop-top ring is then attached with a pin that is separately fabricated. The end is then attached to the can body by an edge rolling process. A similar procedure is done for “easy open” can ends. For easy open can ends, a score substantially around the perimeter of the lid allows for easy opening or removing of the lid from the can, such as by means of a pull tab. For caps and closures, the cap/closure stock may be coated, such as by roll coating, and the cap or closure stamped out of the stock; it is possible, however, to coat the cap/closure after formation. Coatings for cans subjected to relatively stringent temperature and/or pressure requirements should also be resistant to popping, corrosion, blushing and/or blistering.

In more detail, a “package” is anything used to contain another item, such as for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which may range from several months to years. Thus, the present “package” is distinguished from a storage container or bakeware in which a consumer might make and/or store food; such a container would only maintain the freshness or integrity of the food item for a relatively short period. A package according to the present invention can be made of metal or non-metal, for example, plastic or laminate, and be in any form. An example of a suitable package is a laminate tube. Another example of a suitable package is metal can. The term “metal can” includes any type of metal can, container or any type of receptacle or portion thereof that is sealed by the food and/or beverage manufacturer to minimize or eliminate spoilage of the contents until such package is opened by the consumer. One example of a metal can is a food can; the term “food can(s)” is used herein to refer to cans, containers or any type of receptacle or portion thereof used to hold any type of food and/or beverage. The term “metal can(s)” specifically includes food cans and also specifically includes “can ends” including “E-Z open ends”, which may be stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates, and flexible packaging, such as those made from PE, PP, PET, and the like. Such packaging could hold, for example, food, toothpaste, personal care products and the like.

The coating composition can be applied to the interior and/or the exterior of the package.

The coating composition can be applied to the “side stripe” of a metal can, which will be understood as the seam formed during fabrication of a three-piece can. The coating composition could also be applied as a rim coat to the bottom of the can. The rim coat functions to reduce friction for improved handling during the continued fabrication and/or processing of the can. The coating composition can also be applied to caps and/or closures; such application can include, for example, a protective varnish that is applied before and/or after formation of the cap/closure and/or a pigmented enamel post applied to the cap, such as those having a scored seam at the bottom of the cap. Decorated can stock can also be partially coated externally with the coating described herein, and the decorated, coated can stock used to form various metal cans.

The coating composition may be a post repair coating composition, such as a post repair spray coating composition. Such coating compositions are specifically designed to be applied to and thereby coat a score line of the package. During the scoring operation, which is often achieved by stamping with a punch, the external varnish layer is cut and therefore the corrosion resistance of the metal substrate is compromised. This can be particularly problematic in a context where:
i) the metal has been stressed and therefore its resistance to corrosion is weakened; and/or
ii) the tin layer of the tinplate (where this is the substrate) is also cut; and/or
iii) the next treatment step of the packaging is sterilization, where the presence of heat and high humidity will create high corrosion conditions; and/or
iv) the container is at the beginning of its life cycle which has a minimum of two years.

The corrosion resistance of the metal substrate is restored by the application of a post repair coating (derived from a post repair coating composition) to the score line. This coating is often applied by spraying, such as by an airless spray process.

The coating composition may be a single component coating composition (often referred to as a 1K coating composition) or a multiple component coating composition, such as a two-component coating composition (often referred to as a 2K coating composition). Such terminology is well known in the art. In a multiple component coating composition, the components are provided separately but introduced to each other (by mixing, for example) prior to application. This could be hours before application, for example up to 24 hours before application, or up to 12 hours before application or up to 8 hours before application or up to 4 hours before application. In some instances, the multiple components may be introduced to each other (such as by mixing) during the application process, such as in line mixing, for example. If the coating composition is a multiple component coating composition, such as a 2-component coating composition, the thermoplastic particles may be provided in a first component, while other materials may be provided in a further component, (such as a second component). For example, the crosslinker material may be provided in a further component (such as a second component).

The coating composition may be a single component coating composition.

The coating composition may be a 1K coating composition.

Metal coils, having wide application in many industries, are also substrates that can be coated according to the present invention. Coil coatings may comprise a colorant.

The coating composition is applied to at least a portion of the package. For example, when the coating compositions are applied to a food and/or beverage can and/or monobloc aerosol can and/or tube, the coating compositions may be applied to at least a portion of an internal and/or external surface of said food and/or beverage can and/or monobloc aerosol can and/or tube. For example, when the coating composition is applied to a food and/or beverage can, the coating composition may be applied to at least a portion of an internal surface of said food and/or beverage can.

The package may be formed from any suitable material. Suitable materials will be known to a person skilled in the art. Examples of suitable materials include, but are not limited to, steel; tinplate; tinplate pre-treated with a protective material such as chromium, titanium, titanate or aluminum; tin-free steel (TFS); galvanized steel, such as for example electro-galvanized steel; aluminum; aluminum alloy; and combinations thereof. The package may be formed from steel, tinplate, tin-plate pre-treated with a protective material such as chromium, titanium, titanate or aluminum, tin-free steel (TFS), galvanized steel, such as for example electro-galvanized steel or combinations thereof.

The package may be formed from a chromium-free material. As used herein “chromium free” refers to a material that may or may not have undergone a pre-treatment process. Where the material has undergone a pre-treatment process involving passivation, the passivation solutions used are substantially free, may be essentially free or may be completely free of chromium compounds such as, for example, disodium chromate. By “substantially free” we mean to refer to passivation solutions containing less than 1000 parts per million (ppm) of chromium compounds such as, for example, disodium chromate. By “essentially free” we mean to refer to passivation solutions containing less than 100 ppm of chromium compounds such as, for example, disodium chromate. By “completely free” we mean to refer to passivation solutions containing less than 20 parts per billion (ppb) of chromium compounds such as, for example, disodium chromate. The passivation process may not comprise chromium compounds, such as hexavalent chromium compounds. For example, the passivation process may not comprise contacting or immersing a material with and/or in a solution comprising chromium compounds such as hexavalent chromium compounds.

The passivation process may comprise a passivation 505 or 555 method, such as a 505 or 555 passivation method from Arcelor, TATA, or US Steel, and/or a passivation method based on Henkel Granodine 1456. The chromium-free material may be obtained from a commercial source.

The coating composition may be applied to the substrate (package) by any suitable method. Methods of applying the coating composition will be known to a person skilled in the art. Suitable application methods include, but are not limited to, electrocoating such as electrodeposition; spraying; electrostatic spraying; dipping; rolling; brushing; and the like. The coating composition may be applied to the substrate by spraying and/or rolling. For example, the coating composition may be applied by rolling to a flat sheet prior to the substrate (flat sheet) being formed into a can, such as a three-piece can, for example. The coating composition may be applied to a metal substrate by lamination. For example, a film may be formed from the coating composition, which film may subsequently be applied to a metal substrate (package, for example a food or beverage can) by lamination thereon.

The package may be coated at least in part with the coating composition of the present disclosure. The package may comprise, for example, a metal can, and/or a monobloc aerosol can and/or tube. The package may, for example, be used for and/or comprise a food and/or beverage package.

Once the coating is applied to the desired substrate, it can be dried or cured by any suitable means known to those skilled in the art and as appropriate for the chemistry of the film formers. Examples of such suitable curing techniques include, without limitation: baking in a thermal oven, induction heating, infrared heating, exposure to actinic radiation, and/or combinations thereof.

The coating compositions of the present disclosure may comprise any coating layer such as a primer, a colored basecoat, and/or a topcoat. The coating layer deposited from the present composition may have one or more additional coating layers deposited under and/or over the layer. For example, the coating layer of the present disclosure may comprise a first coating and one or more additional layers, that are the same or different from the coating compositions of the present disclosure, may be applied over at least a portion of the first coating. One of more additional coatings may be applied to the at least partially cured first coating such as silicone modified polyester coating composition, a polyvinylidene fluoride coating composition, or combinations thereof. One or more additional coatings may also be applied under the coating layer formed from the present composition.

Coatings compositions of the present disclosure may be applied to a substrate by any method, and substrates may be coated by any method, such as applying to at least a portion of the substrate, a first coating comprising the coating composition of the present disclosure, and optionally, applying one or more additional coatings to at least a portion of the first coating, such as, wherein the one or more additional coatings comprise the coating composition of the present disclosure, a silicone modified polyester coating composition, a polyvinylidene fluoride coating composition, or combinations thereof.

The substrate coated at least in part with the coating compositions of the present disclosure may comprise any substrate. For example, the substrate coated at least in part with the coating compositions of the present disclosure may comprise plastic, such as polycarbonate, glass, wood, or metal or metal alloy, such as aluminum or steel, such as in the form of a metal sheet or coil. The substrate coated at least in part with the coating compositions of the present disclosure, may comprises at least one additional coating layer, such as, wherein the one or more additional coating layers comprise the coating composition according to the present disclosure, a silicone modified polyester coating layer, a polyvinylidene fluoride coating layer, or combinations thereof.

The substrate coated using such methods, and the coated substrate therefrom, may comprise any substrate such as in non-limiting examples, a vehicle, a personal electronic device, a package, a three-dimensional component formed by an additive manufacturing process, and/or components thereof. The substrate coated using such methods, and the coated substrate therefrom, may comprise any substrate a package, wherein the package comprises a metal can, and/or a monobloc aerosol can and/or tube, and/or the package is a food and/or beverage package.

Coating compositions prepared in accordance with the present disclosure may be used to manufacture coating compositions that are substantially/essentially/completely free of catalytic tin.

Whereas examples of this disclosure have been described above for purposes of illustration, it will be evident to those skilled in the art that numerous variations of the details of the present disclosure may be made without departing from the disclosure as defined in the appended claims.

### EXAMPLES

The following examples are intended to illustrate the disclosure and should not be construed as limiting the disclosure in any way.

### Polymer Test Methods

Unless otherwise stated, polymers were analyzed using the following test methods.

Weight % Solids: Unless otherwise stated, weight percent solids was calculated as follows: A sample (of approximately one gram) was weighed accurately and placed into an aluminum dish of known mass. A few grams of acetone were pipetted onto the sample to thin out the material and facilitate the evaporation of the solvent from the aluminum dish when heated. The sample was placed in a forced draft oven (Type IIA or Type IIB and conforming to specifications outlined in ASTM E145). The sample was heated under forced draft conditions for 2 hours at 150° C. The sample was then reweighed. The mass after heating was compared with the original mass of the sample, to determine the weight percent solids of the sample.

Molecular weight: Unless otherwise stated, molecular weight was determined by gel permeation chromatography using a polystyrene standard according to ASTM D6579-11 (“Standard Practice for Molecular Weight Averages and Molecular Weight Distribution of Hydrocarbon, Rosin and Terpene Resins by Size Exclusion Chromatography”) using a UV detector at 254 nm (nanometer) and solvent of un-stabilized THF. The retention time marker was toluene, and the sample concentration was 2 mg/ml (milligram/milliliter). Molecular weight was reported as Mn (number average molecular weight), Mw (weight average molecular weight) and PDI (polydispersity index) calculated using the following equation:

$$PDI = M w / M n$$

Acid value (AV): Unless otherwise stated, AV was determined by titration with 0.1M methanolic potassium hydroxide (KOH) solution. A sample (0.1 gram (g)) was weighed accurately into a conical flask and dissolved using agitation and light heating to 50° C. in 25 milliliters (ml) of tetrahydrofuran that contained phenolphthalein indicator. The solution was then cooled to room temperature and titrated with the 0.1M methanolic potassium hydroxide solution. Acid value is expressed in units of mg KOH/g and was calculated using the following equation:

$$Acid value = volume of KOH solution ( ml ) \times molarity of KOH solution ( M ) \times 56.1 / weight of solid sample ( g )$$

Hydroxyl value (OHV): The hydroxyl value is the number of mg of KOH equivalent to the hydroxyl groups in 1 g of material. Unless otherwise stated, the OHV was determined using the following method: a sample (0.13 g) was weighed accurately into a conical flask. The resin sample was dissolved using agitation and light heating to 50° C. in 20 ml of tetrahydrofuran, 10 ml of 0.1M 4-(dimethylamino)pyridine in tetrahydrofuran, and 5 ml of a 9% by volume solution of acetic anhydride in tetrahydrofuran. After 5 minutes, 10 ml of an 80% by volume solution of tetrahydrofuran in distilled water was added. After an additional 15 minutes, 10 ml tetrahydrofuran was added, and the solution was titrated with 0.5M ethanolic potassium hydroxide (KOH). A blank sample without resin was also run. The resulting hydroxyl number is expressed in units of mg KOH/g and was calculated using the following equation:

$$Hydroxyl value = ( {V}_{2} - {V}_{1} ) \times molarity of KOH solution ( M ) \times 56.1 / weight of solid sample ( g )$$

wherein V₁, is the volume of KOH solution (ml) of the test sample and V₂ is the volume of KOH solution (ml) of the blank sample.

Isocyanate (NCO) equivalent weight: Unless otherwise stated, NCO equivalent weight was determined using ASTM D1638-74 (Standard Methods of Testing Urethane Foam Isocyanate Raw Materials) revised as described herein: A dibutylamine solution of 78 g dibutylamine (available from Sigma Aldrich) in 4 liters of N-methyl-2-pyrrolidone (available from Fisher Scientific) was prepared in advance of sample testing. A sample having a weight between 1 and 2 grams was weighed accurately into a flask. The sample was reacted with 33 ml of the dibutylamine to form a substituted urea. The excess dibutylamine was then back-titrated with a solution of 0.2N hydrochloric acid in isopropyl alcohol (solution available from Fisher Scientific-Ricca). The amount of hydrochloric acid used to back-titrate the excess dibutylamine was used to calculate NCO equivalent weight of the original sample.

### Example 1 Polyester Coating Compositions

Coating compositions were prepared with a first coating comprising a film-forming polyester produced using a catalyst system as described in this disclosure and a topcoat.

### Preparation of Polyester Polymers (POLYMERS 1-3)

A polyester prepolymer (PREPOLYMER) was prepared using the materials listed in Table 1. The materials were added as a batch to a vessel fitted with a steam column, distillation head and condenser with receiver vessel. The batch temperature was increased to 180° C. with continuous stirring at 400 revolutions per minute (rpms) and a nitrogen gas blanket at 0.5 SCFH (standard cubic feet per hour). Once the temperature of the distillate had dropped below 90° C. the batch temperature was increased to 220° C. by increasing the temperature in 10° C. steps each 30 minutes.

Once the reaction temperature had reached 220° C. the acid value (AV) of the polymer was checked until AV dropped below a value of 20. When AV<20, the PREPOLYMER was poured into three separate flasks to use in producing POLYMERS 1-3. Prepolymer properties were analyzed as shown in Table 2.

TABLE 1
Polyester Prepolymer (PREPOLYMER)

| | PREPOLYMER |
|---|---|
| Starting Materials | (grams) |
| 2-methyl-1,3-propanediol¹ | 734.80 |
| Trimethylolpropane² | 24.86 |
| Isophthalic acid³ | 567.60 |
| Phthalic Anhydride⁴ | 503.80 |
| Adipic Acid⁵ | 172.26 |

¹Available from LyondellBasell
²Available from Baichuan Chemical Co., Ltd.
³Available from Mitsubishi Chemical Corp.
⁴Available from Arkema
⁵Available from Invista

TABLE 2
PREPOLYMER PROPERTIES

| Final Properties | PREPOLYMER |
|---|---|
| % Solids Final Resin | 98.74 |
| Mn | 2677 |
| Mw | 5263 |
| PDI | 2.0 |
| AV | 18.93 |
| OHV | 41.48 |

A catalyst premix (PREMIX) was separately prepared using a 1:1 molar equivalent ratio of a titanium catalyst and a bismuth catalyst. In a nitrogen environment, 27.0 mL of titanium (IV) butoxide (CAS: 5593-70-4 as supplied by Sigma-Aldrich) (TBT) and 50.0 mL of Bismuth Neodecanoate (CAS: 34364-26-6 as supplied by American Elements) were added to a 4 oz jar. The PREMIX was stirred for 5 minutes with a spatula to ensure good mixing. The jar was observed to warm to the touch somewhat during mixing. A cap was then installed with parafilm around the lid. The PREMIX was used within one week of preparation.

Polyester polymers (POLYMERS 1-3) were made using the PREPOLYMER and the materials shown in Table 3. The PREPOLYMER was poured into three separate flasks. A steam column, distillation head and condenser with receiver vessel were attached to each flask. Catalysts were added to the flasks in the amounts specified in Table 3. The batch was heated to 220° C. and AV samples were taken to monitor the reaction progression.

TABLE 3
POLYMERS 1-3

| | POLYMER 1 | POLYMER 2 | POLYMER 3 |
|---|---|---|---|
| Starting Materials | (grams) | (grams) | (grams) |
| PREPOLYMER | 402.20 | 408.10 | 417.20 |
| TBT | 0.57 | | 0.57 |
| PREMIX | | 1.80 | |
| Bismuth | | | 1.21 |
| Neodecanoate | | | |
| Aromatic 100⁶ | 39.83 | 40.42 | 39.83 |
| Dowanol PM Acetate⁷ | 39.83 | 40.42 | 39.83 |
| N-Butanol⁸ | 133.82 | 135.79 | 133.82 |

⁶Mixture of C8 and C9 hydrocarbons, Available from ExxonMobil
⁷Propylene Glycol Monomethyl Ether Acetate, Available from Dow Chemical
⁸Available from Sigma-Aldrich

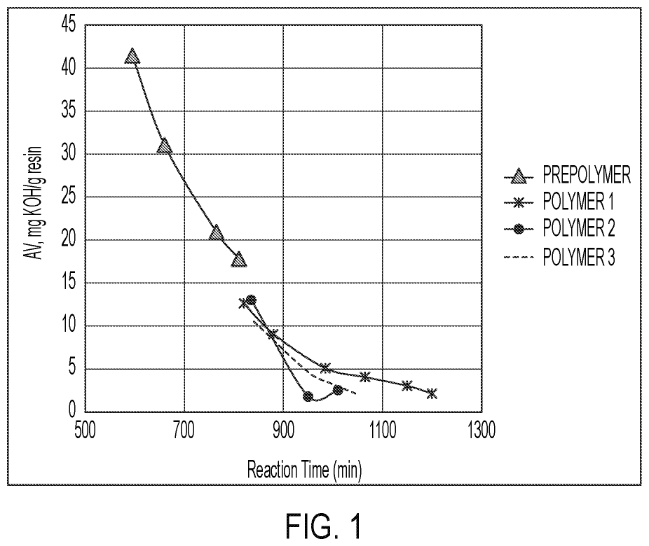

FIG. 1 shows a graph of AV vs. reaction time for the PREPOLYMER and POLYMERS 1-3. As shown, the reaction rate as monitored by residual AV was fastest for POLYMER 2, made using the PREMIX. POLYMER 3, made using the catalytic system as disclosed herein, wherein the components were not premixed, but were added individually, proceeded at the second fastest rate. The reaction rate for POLYMER 1 with TBT only was slowest.

Properties of POLYMERS 1-3 are shown in Table 4. As shown in Table 4, catalyst systems as disclosed herein were used to successfully produce polyester resins. Polymers using the catalysts systems as disclosed herein were used to successfully produce polyester resins with reduced reaction times relative to use of a single catalyst.

TABLE 4
PROPERTIES OF POLYMERS 1-3

| Polymer | | | |
|---|---|---|---|
| Properties | POLYMER 1 | POLYMER 2 | POLYMER 3 |
| % Solids Final | 64.38 | 70.08 | 62.62 |
| Resin | | | |
| Mn | 5306 | 5900 | 4454 |
| Mw | 15265 | 17467 | 11227 |
| PDI | 2.9 | 3.0 | 2.5 |
| AV | 2.14 | 2.53 | 2.17 |
| OHV | 21.60 | 23.15 | 22.83 |

### Preparation and Performance of Polyester Coatings (COATINGS 1-6)

GRINDPASTES 1-6 were prepared by adding POLYMERS 1-3 to separate 1-quart unlined metal cans with the chime removed. While agitating the resin with a flat mixing blade, pigments were slowly added. The solvent blend was added to maintain an appropriate viscosity to allow mixing. Once the complete pigment loading was added, 200 grams of ZIRCOA ceramic beads (2 mm) was added. The grind paste was agitated at high speed for approximately 45 min until a Hegman grind of 7.0 was achieved as tested using ASTMD1210-96. (Standard Test Method for Fineness of Dispersion of Pigment-Vehicle Systems by Hegman-Type Gage). An ice water bath was used during grinding to control temperature. The resulting paste was sieved through a wire mesh screen to remove the ZIRCOA beads, collected in tare weighed 1-pint unlined metal cans and reweighed.

TABLE 4
GRINDPASTES 1-6

| | GRIND PASTES | | | | | |
|---|---|---|---|---|---|---|
| | GRIND | GRIND | GRIND | GRIND | GRIND | GRIND |
| | PASTE 1 | PASTE 2 | PASTE 3 | PASTE 4 | PASTE 5 | PASTE 6 |
| | (grams) | (grams) | (grams) | (grams) | (grams) | (grams) |
| POLYMER 1 | 118.96 | 118.95 | | | | |
| POLYMER 2 | | | 109.30 | 109.61 | | |
| POLYMER 3 | | | | | 122.12 | 122.47 |
| ASP200⁹ | 19.87 | 19.79 | 19.87 | 19.85 | 19.84 | 19.82 |
| HEUCOPHOS | 13.27 | 9.03 | 13.27 | 9.05 | 13.25 | 9.04 |
| SRPP¹⁰ | | | | | | |
| TIONA 696¹¹ | 59.61 | 59.38 | 59.62 | 59.56 | 59.52 | 59.46 |
| MAGCHEM | 8.41 | 16.75 | 8.41 | 16.80 | 8.40 | 16.78 |
| 200AD¹² | | | | | | |
| SHIELDEX CS | 13.27 | 9.03 | 13.27 | 9.05 | 13.25 | 9.04 |
| 311¹³ | | | | | | |
| TS-610¹⁴ | 59.61 | 59.38 | 59.62 | 59.56 | 59.52 | 59.46 |
| Solvent Blend¹⁵ | 87.60 | 84.45 | 97.39 | 99.66 | 81.80 | 82.04 |
| TOTAL | 321.43 | 318.28 | 321.59 | 324.49 | 318.63 | 319.54 |
| GRIND | | | | | | |
| Weight | 249.20 | 239.10 | 249.60 | 225.00 | 231.67 | 216.90 |
| Recovered After | | | | | | |
| Sieving | | | | | | |
| Weight % Yield | 77.5% | 75.1% | 77.6% | 69.3% | 72.7% | 67.9% |
| After Sieving | | | | | | |

⁹Aluminum Silicate - Hydrous that is available from KAMIN LLC
¹⁰Strontium Aluminum Polyphosphate Hydrate available from HEUBACH
¹¹Titanium Dioxide available from CRISTAL GLOBAL
¹²Magnesium Oxide available from MARTIN MARIETTA MAGNESIA SPECIALTY LLC
¹³Silica available from GRACE
¹⁴Silica available from Evonik Industries
¹⁵50:50 weight ratio solvent blend of Solvesso 100 aromatic solvent available from Exxon:Butyl Cellosolve (2-butoxy ethanol)

To make COATINGS 1-6, the remaining liquid components shown in Table 5 were added to GRINDPASTES 1-6. The mixtures were agitated with a Cowles blade for 5 minutes, then the Halox 650 was added to each sample to the sample under agitation. The compositions, COATINGS 1-6, were mixed for 10 minutes. The Hegman grind was checked using the test method described in ASTM D1210.

TABLE 5
COATINGS 1-6

| | COATINGS | | | | | |
|---|---|---|---|---|---|---|
| | COATING 1 | COATING 2 | COATING 3 | COATING | COATING 5 | COATING 6 |
| | (grams) | (grams) | (grams) | 4(grams) | (grams) | (grams) |
| GRINDPASTE 1 | 249.20 | | | | | |
| GRINDPASTE 2 | | 239.10 | | | | |
| GRINDPASTE 3 | | | 249.60 | | | |
| GRINDPASTE 4 | | | | 225.00 | | |
| GRINDPASTE 5 | | | | | 231.67 | |
| GRINDPASTE 6 | | | | | | 216.90 |
| POLYMER 1 | 22.62 | 21.92 | | | | |
| POLYMER 2 | | | 20.81 | 18.26 | | |
| POLYMER 3 | | | | | 21.79 | 19.99 |
| Phosphatized | 8.12 | 7.87 | 8.13 | 7.26 | 7.61 | 7.10 |
| Resin¹⁶ | | | | | | |
| CYMEL LF303¹⁷ | 3.90 | 3.78 | 3.90 | 3.48 | 3.65 | 3.41 |
| REAXIS C218¹⁸ | 1.36 | 1.32 | 1.36 | 1.21 | 1.27 | 1.19 |
| DIAZ 2770 | 0.40 | 0.39 | 0.41 | 0.36 | 0.38 | 0.35 |
| Polymer¹⁹ | | | | | | |
| ETHYLHEXYL | 2.17 | 2.10 | 2.17 | 1.94 | 2.03 | 1.89 |
| POLYMER²⁰ | | | | | | |
| TOLONATE D2²¹ | 11.02 | 10.68 | 11.03 | 9.84 | 7.54 | 6.82 |
| Solvent Blend²² | 6.44 | 8.60 | 8.15 | 5.63 | 10.32 | 9.63 |
| HALOX 650²³ | 0.81 | 0.79 | 0.81 | 0.72 | 0.76 | 0.71 |
| TOTAL | 306.03 | 296.54 | 306.38 | 273.70 | 287.02 | 267.98 |
| COATINGS | | | | | | |
| Hegman Grind | 7.0 | 7.0 | 7.0 | 7.0 | 7.0 | 7.0 |
| COATING | 60.0% | 59.9% | 60.0% | 60.1% | 72.7% | 67.9% |
| Weight % Solids | | | | | | |

¹⁶Epoxy Resin with acid value = 95, available from PPG
¹⁷Melamine-formaldehyde resin available from ALLNEX
¹⁸Dibutyltin Dilaurate Available from Reaxis Inc.
¹⁹Hyperbranched Hydrocarbon Polymer, Available from Baker Hughes
²⁰Acrylic homopolymer with average weight molecular weight of approximately 10,000 available from PPG
²¹MEKO blocked HMDI Isocyanate available from Vencorex Chemicals
²²50:50 solvent blend of Solvesso 100:Butyl Cellosolve
²³2-Benzothiazolythio Butanedioic Acid, Available from ICL/HALOX

COATINGS 1-6 were applied to 4-inch×6-inch hot dipped galvanized (HDG) steel panels precoated with Bonderite 1421 available from Precoat Steel; the gauge of the metal was 0.015 inches. COATINGS 1-6 were applied to the panels using a #10 wire wound bar, resulting in a coating dry film thickness of 5-7 microns after cure. The coated panels were cured in an Aalborg oven available from the Aalborg Company, Inc. The panels were placed in the oven for 30 seconds at 540° F., removed, and quenched in water.

Methylethylketone (MEK) double rub resistance was evaluated on the cured COATINGS 1-6 using the following method. A 2-inch×2-inch square of a WYPALL disposable wiper was moistened with MEK and manually rubbed back and forth across the same point on the coated panel. A single double rub was counted as the back-and-forth motion. MEK double rub performance was reported as the number of double rubs until coating breakthrough.

As shown in Table 6, cured film panels with COATINGS 1-6 all had some MEK resistance. COATINGS 3-4, made with the reduced reaction time POLYMER 2 using the PREMIX, had similar MEK resistance to the performance of COATINGS 1-2 with the longest reaction time POLYMER 1 using only TBT.

TABLE 6
COATINGS 1-6

| COATING | COATING 1 | COATING 2 | COATING 3 | COATING 4 | COATING 5 | COATING 6 |
|---|---|---|---|---|---|---|
| MEK double | 9 | 8 | 8 | 7 | 5 | 4 |
| rubs | | | | | | |

### Preparation and Performance of COATINGS 1-6 and a Topcoat

Additional sets of panels made with COATINGS 1-6, coated and cured as described above, were coated with DURASTAR UC Fox Gray BR5A117B commercially available from PPG. The topcoat was applied using a #30 wire wound bar, resulting in a topcoat dry film thickness of 18-20 microns after cure. The topcoat was cured using the same oven conditions as were used to cure COATINGS 1-6.

Boiling water adhesion testing was evaluated on panels coated using COATINGS 1-6 and the topcoat. Coated panels were tested initially, and a second set of coated panels was allowed to age for one month at ambient temperature prior to testing. Boiling water adhesion testing was performed as follows: The panels were scribed using a 2-millimeter (mm) Cross-Cut Guide for Adhesion Testing available from KTA-Tator, Inc. Eleven initial cuts were made using the guide; the guide was then rotated, and an additional eleven cuts were made on the same area, resulting in 100 (2-mm×2-mm) crosshatch squares. The crosshatched portion of the panel was then reverse impacted (struck from the reverse) from the coated side of the panel, using a 2-pound ball punch on the Gardner Impact Tester PF-1120 available from Byk-Gardner. The inch-pound (“in-lb”) setting is determined by the gauge of the coated metal substrate. For steel, the in-lb setting is 3,000× the gauge of the substrate in inches. For this substrate, the gauge of the steel substrate was 0.015 inches, and the in-lb setting was 45. After crosshatching and reverse impacting, the panels were placed in boiling water for thirty minutes, patted dry and immediately evaluated for adhesion using SCOTCH brand 610 tape according to ASTM D3359-97 (Standard Test Methods for Measuring Adhesion by Tape Test).

As shown in Table 7, the boiling water adhesion performance of all panels was similar. COATINGS 3-4, with the fastest polymerization rate POLYMER 3, made using the PREMIX, and COATINGS 5-6, with the second fastest polymerization rate POLYMER 2 using the catalytic system wherein the catalysts, TBT and Bismuth Neodecanoate were added individually, performed equally to Coatings 1-2 using the slowest polymerization rate POLYMER 1 with TBT.

As shown in Table 7, polyester polymers produced using the catalytic systems disclosed herein had reduced polymerization reaction time without sacrificing performance of coatings made using these polymers.

TABLE 7
Boiling Water Adhesion of Panels made with COATINGS 1-6 and a Topcoat

| | Coated Panel Aging | | | | | |
|---|---|---|---|---|---|---|
| | COATING 1 | COATING 2 | COATING 3 | COATING 4 | COATING 5 | COATING 6 |
| Initial | No | No | No | No | No | No |
| | Pick/No | Pick/No | Pick/No | Pick/No | Pick/No | Pick/No |
| | Crack | Crack | Crack | Crack | Crack | Crack |
| 1 Month | No | No | No | No | No | No |
| Ambient | Pick/No | Pick/No | Pick/No | Pick/No | Pick/No | Pick/No |
| | Crack | Crack | Crack | Crack | Crack | Crack |

### Example 2 Polyurethane Coating Compositions

Coating compositions were prepared with a polyurethane coating system using catalysts or catalyst mixtures as described in this disclosure.

### Preparation of Polyurethane Polymers (POLYMERS 4-5)

Polyurethane polymers (POLYMERS 4-5) were prepared using a tin catalyst (Reaxis C218) or the catalyst system (PREMIX) as disclosed herein, and the components shown in Table 8. The tin catalyst in POLYMER 4 and the PREMIX in Polymer 5 were added on an equimolar basis.

For POLYMERS 4-5, the materials in Charge 1 were added to four necked reaction flasks outfitted with a stirrer, gas inlet, thermometer, and condenser. After the exotherm subsided, the temperature was raised to 80° C. The NCO equivalent weight was followed until the reaction stalled. The reaction was cooled to 50° C. Charge 2 was added and the reaction was allowed to exotherm. Once the exotherm subsided, the reaction was held at 65° C. until the NCO peak in the IR spectrum at 2260 cm-1 was no longer present. An aqueous dispersion was produced by adding Charge 3 and Charge 4.

As shown in Table 8, POLYMER 5, produced using the PREMIX catalyst, reached the Charge 1 desired NCO equivalent weight within 2 hours, a reduced reaction time as compared with the tin catalyst, POLYMER 4.

The PREMIX catalytic system of the present disclosure was successful in forming an aqueous polyurethane.

TABLE 8
POLYMERS 4-6

| | | POLYMER 4 | POLYMER6 |
|---|---|---|---|
| Charge | Starting materials | (grams) | (grams) |
| 1 | Terethane 650²⁴ | 130.0 | 130.0 |
| | Dimethylol Propionic Acid²⁵ | 53.6 | 53.6 |
| | Isophorone Diisocyanate²⁶ | 177.6 | 177.6 |
| | Methyl Ethyl Ketone(MEK)²⁷ | 154.9 | 154.9 |
| | Reaxis C218²⁸ | 0.18 | |
| | PREMIX | | 0.30 |
| | MEK | 154.9 | 154.9 |
| 2 | Diethanol Amine²⁹ | 42.0 | 41.2 |
| | MEK | 17.9 | 17.5 |
| 3 | Dimethyl Ethanol Amine | 25.0 | 25.0 |
| 4 | Deionized Water | 551.0 | 555.6 |
| | Charge 1 Reaction Observation | Polymer 4 | Polymer 6 |
| | Hold time (hours) at 80° C. to reach | 3 | 2 |
| | approximate theoretical NCO | | |
| | NCO equivalent | 1289 | 1302 |
| | (g resin solids/equivalent) | | |

²⁴Poly(THF) polyol available from BASF
²⁵Available from Jiangxi Nancheng Hongdu Chemical
²⁶Available from Vencorex Chemicals
²⁷Available from Univar Solutions
²⁸Dibutyltin Dilaurate Available from Reaxis Inc.
²⁹Available from BASF

### Preparation and Performance of Polyurethane Coatings (COATINGS 7-8)

COATINGS 7 and 8 were made using POLYMERS 4-5 and an isocyanate crosslinker (EHW8224 commercially available from PPG) using the mix ratios by weight as shown in Table 9.

The coatings were applied to electrocoated panels (cold rolled steel with ED7100 electrocoat, available from ACT Test Panels LLC, Hilldale, MI) using an 8-mil gap draw down bar and flashed at ambient temperature for 10 minutes before being baked at 60° C. for 45 minutes.

Performance of the cured panels were evaluated after 7 days aging at ambient temperature by measuring MEK double rub resistance. The MEK solvent resistance was tested on cured coating compositions using the following procedure. Test panels were placed on a flat firm surface. Two sterile gauze pads were stacked, one on top of the other, and then affixed over the ball end of a one-pound Ball-Peen hammer. The gauze was held snugly in place with an elastic rubber band in such a fashion as to have 4 layers of gauze secured, with no wrinkles, over the end of the hammer. The pad was saturated with MEK initially; the pads were re-saturated every 25 double rubs. Immediately after saturation with solvent, the pads were rubbed over the test area using a back-and-forth stroke of 2 to 4 inches. The weight of the hammer controlled the downward pressure; no downward or upward pressure was exerted on the hammer handle. The back-and-forth action was continued counting one “double rub” for each forward and backward motion. The double rub test was continued until bare substrate was exposed in the center of the rub strip, or until 100 double rubs were completed without exposure of bare substrate. The MEK double rub resistance was reported as whichever was higher; the number of double rubs to exposure of bare substrate, or completion of 100 double rubs without exposure of bare substrate. The gauze was removed and replaced between testing of each individual sample.

As shown in Table 9, the MEK rub resistance of a panel coated with COATING 8 using POLYMER 5 with the catalyst system of the present disclosure, matched the MEK rub resistance of a panel coated with COATING 7 using POLYMER 4 with the tin catalyst.

The polymer produced using the catalytic system as disclosed herein was used to successfully produce a polyurethane polymer. The polymer produced using the catalytic system as disclosed herein had reduced reaction time to form the polymer relative to the polymer formed using tin catalyst, without sacrificing coating performance.

TABLE 9
COATINGS 7-8

| Polyurethane Coating | COATING 7 | COATING 8 |
|---|---|---|
| POLYMER 4 | 5.00 | |
| POLYMER 6 | | 5.00 |
| EHW8224 | 2.11 | 2.10 |
| Cured Coating System | | |
| Performance (7 days aged) | | |
| MEK double rubs | 100 | 100 |

²¹Isocyanate available from PPG

1. A coating composition comprising a film-forming polymer formed from a reaction mixture comprising a catalytic system comprising a first catalyst comprising titanium, zirconium, or combinations thereof; and a second catalyst comprising bismuth, aluminum, zirconium, or combinations thereof; wherein the metal in the first catalyst is different from the metal in the second catalyst.

2. The coating composition of claim 1, wherein the first catalyst comprises Ti(OR¹)₄, wherein R¹ is an alkyl or aryl or the first catalyst comprises Zr(OC(O)R²) 3, wherein R² is an alkyl or aryl, and the second catalyst comprises Bi(OC(O)R³) 3, wherein R³ is an alkyl or aryl, and/or the second catalyst comprises Al(OC(O)R⁴) 3, wherein R⁴ is an alkyl or aryl, or the second catalyst comprises Zr(OC(O)R⁵) 3, wherein R⁵ is an alky or aryl.

3. The coating composition of claim 1, wherein the first catalyst comprises titanium, and the second catalyst comprises bismuth.

4. The coating composition of claim 1, wherein the film-forming polymer comprises a polyester, and/or a polyurethane.

5. A coating composition comprising a polyester and/or a polyurethane film-forming polymer formed from a reaction mixture comprising a catalytic system comprising a first catalyst comprising titanium; and a second catalyst comprising bismuth.

6. The coating composition of claim 4, wherein the polyester comprises a reaction product of a polyacid, or an ester or anhydride thereof, and a polyol, and/or the polyester comprises hydroxyl functional groups, and/or carboxyl functional groups.

7. The coating composition of claim 4, wherein the polyurethane comprises a reaction product of a polyol, and a polyisocyanate, and/or the polyurethane comprises hydroxyl functional groups.

8. The coating composition of claim 1, wherein the first catalyst and second catalyst are premixed prior to addition to the reaction mixture.

9. The coating composition of claim 1, wherein the catalytic system comprises from 3 to 96 parts by weight of the first catalyst and from 4 to 97 parts by weight of the second catalyst based on the total weight of the catalytic system.

10. The coating composition of claim 1, wherein the total weight of the catalytic system is no more than 2 percent by weight on resin solids of the film-forming polymer.

11. The coating composition of claim 1, wherein the coating composition further comprises a crosslinker.

12. The coating composition of claim 1, wherein the film-forming polymer and/or the coating composition are substantially free, essentially free and/or completely free of catalytic tin.

13. The coating composition of claim 1, wherein the coating composition is a liquid coating composition, or a powder coating composition.

14. A method for using the coating composition of claim 1 to coat a substrate comprising: applying to at least a portion of the substrate, a first coating comprising the coating composition of claim 1, and optionally, applying one or more additional coatings to at least a portion of the first coating, wherein the one or more additional coatings comprise the coating composition of claim 1, a silicone modified polyester coating composition, a polyvinylidene fluoride coating composition, or combinations thereof.

15. A substrate coated at least in part with a coating layer deposited from the coating composition of claim 1.

16. The substrate of claim 15, wherein the substrate comprises plastic, glass, wood, metal, or metal alloy.

17. The substrate of claim 15, wherein the substrate comprises at least one additional coating layer, wherein the additional coating layer is deposited from the coating composition of claim 1, a silicone modified polyester coating layer, a polyvinylidene fluoride coating layer, or combinations thereof.

18. The substrate of claim 15, wherein the substrate comprises a vehicle, a personal electronic device, a package, a three-dimensional component formed by an additive manufacturing process, and/or components thereof.

19. A package, according to claim 18, wherein the package comprises a metal can, and/or a monobloc aerosol can and/or tube, and/or the package is a food and/or beverage package.

20. (canceled)
